(19) United States
(12) Patent Application Publication
(10) Pub. No.: US 2026/0280136 A1
(43) Pub. Date: Sep. 17, 2026

(54) RADIO TRANSMISSION SYSTEM

(71) Applicant: AGC Inc., Tokyo (JP)

(72) Inventor: Kumiko KAMBARA, Tokyo (JP)

(73) Assignee: AGC Inc., Tokyo (JP)

(21) Appl. No.: 19/675,226

(22) Filed: May 12, 2026

Related U.S. Application Data
(63) Continuation of application No. PCT/JP2024/037795, filed on Oct. 23, 2024.

(30) Foreign Application Priority Data
Nov. 13, 2023 (JP) 2023-193053

(51) Int. Cl. H01Q 15/00; H04B 7/04

(52) U.S. Cl. CPC H01Q 15/0013; H04B 7/04013

(57) ABSTRACT

A radio transmission system in which the communication environment is improved by an electromagnetic-wave reflecting apparatus is provided. The radio transmission system comprises: a transmitting antenna configured to transmit a radio wave in a predetermined frequency band selected from frequencies ranging from 1 GHz to 300 GHz; a receiving antenna configured to receive a radio wave in the frequency band; and an electromagnetic-wave reflecting apparatus configured to form a reflection surface which reflects a radio wave in the frequency band. The electromagnetic-wave reflecting apparatus includes a reflection surface formed of one or more reflection panels. A distance d1 from the transmitting antenna to a reflection point on the reflection surface, a distance d2 from the reflection point to the receiving antenna, a wavelength λ of the frequency band, and a length L of a side or a short side of the reflection surface satisfy L≥2×[λ·d1·d2/(d1+d2)]^{1/2}.

### INCORPORATION BY REFERENCE

This application is based upon and claims the benefit of priority from Japanese patent application No. 2023-193053 filed on Nov. 13, 2023, and PCT application No. PCT/JP2024/037795 filed on Oct. 23, 2024, the disclosure of which is incorporated herein in its entirety by reference.

### BACKGROUND

The present invention relates to a radio transmission system.

In order to, for example, implement automation of manufacturing processes and office work, remote control, control and management using AI (Artificial Intelligence), and unattended operations, radio base stations have been increasingly introduced indoors and outdoors. Radio base stations have also been increasingly introduced or considered to be introduced indoors such as factories, plants, offices, and commercial facilities, and outdoors such as highways and railway tracks, as well as other indoor or outdoor situations such as medical sites and event venues.

In 5th generation mobile communication standards (hereinafter referred to as “5G”), frequency bands at 6 GHz or lower called “sub-6” and 28 GHz bands which are classified as millimeter-wave bands are provided. In the next-generation 6G mobile communications standards, it is expected that the frequency band will be extended to sub-terahertz bands. By using such high-frequency bands, the communication bandwidth is greatly extended, so that a large amount of data can be communicated with a small delay. It has been proposed that electromagnetic-wave reflecting apparatuses be disposed along at least parts of production lines in factories (see, e.g., International Patent Publication No. WO 2021/199504).

### SUMMARY

The radio communication environment of a local area network (LAN) introduced into a factory, a plant, a commercial facility, or the like is different from that of a public mobile communication network. In a facility, machines and structures that interfere with propagation of communication radio waves are present, and thus it is difficult to achieve high communication quality. One means by which the radio communication environment in the facility may be improved is the use of an electromagnetic-wave reflecting apparatus. One of the objects of the present invention is to provide a radio transmission system in which the communication environment is improved by an electromagnetic-wave reflecting apparatus.

In an embodiment, a radio transmission system comprises:
a transmitting antenna configured to transmit a radio wave in a predetermined frequency band selected from frequencies of 1 GHz or higher and 300 GHz or lower;
a receiving antenna configured to receive a radio wave in the frequency band; and
an electromagnetic-wave reflecting apparatus configured to form a reflection surface which reflects a radio wave in the frequency band, wherein
the electromagnetic-wave reflecting apparatus includes a reflection surface formed of one or more reflection panels, and
when a distance from the transmitting antenna to a reflection point on the reflection surface is denoted as d1 [m], a distance from the reflection point to the receiving antenna is denoted as d2 [m], and a wavelength of the frequency band is denoted as λ [m], a length L [m] of a side or a short side of the reflection surface is formed so as to satisfy

$$L \geq 2 \times {[ λ \cdot d 1 \cdot d 2 / ( d 1 + d 2 ) ]}^{1 / 2} .$$

A radio transmission system in which the communication environment is improved by an electromagnetic-wave reflecting apparatus is provided.

The above and other objects, features and advantages of the present disclosure will become more fully understood from the detailed description given hereinbelow and the accompanying drawings.

### BRIEF DESCRIPTION OF DRAWINGS

FIG. 1 is a schematic diagram of an electromagnetic-wave reflecting apparatus used in a radio transmission system according to an embodiment;

FIG. 2 is a horizontal cross-sectional view of frames which hold a reflection panel of the electromagnetic-wave reflecting apparatus;

FIG. 3 is a schematic diagram showing reflection on a reflection surface including a metasurface; and

FIG. 4 is a schematic diagram showing reflection on a specular reflection surface.

### DESCRIPTION OF EMBODIMENTS

In an embodiment, an electromagnetic-wave reflecting apparatus including a reflection surface of an appropriate size is installed at an appropriate position or angle, to thereby improve the communication environment or the radio wave environment of a radio transmission system. In general, electromagnetic waves of 3 THz or lower are referred to as radio waves. In this specification, however, communication waves transmitted from a base station may be referred to as “radio waves”.

A configuration of a radio transmission system according to an embodiment will be described hereinafter with reference to the drawings. Embodiments described below are merely examples used to make the technical concept of the present invention concrete, and is not intended to limit the scope of the present invention. The sizes of the members shown in the drawings, the positional relationships among these members, and the like shown in the drawings may be exaggerated as appropriate in order to facilitate the understanding of the invention. In the following description, the same components or functions are denoted by the same names or reference symbols, and redundant descriptions thereof may be omitted.

### <Radio Transmission System>

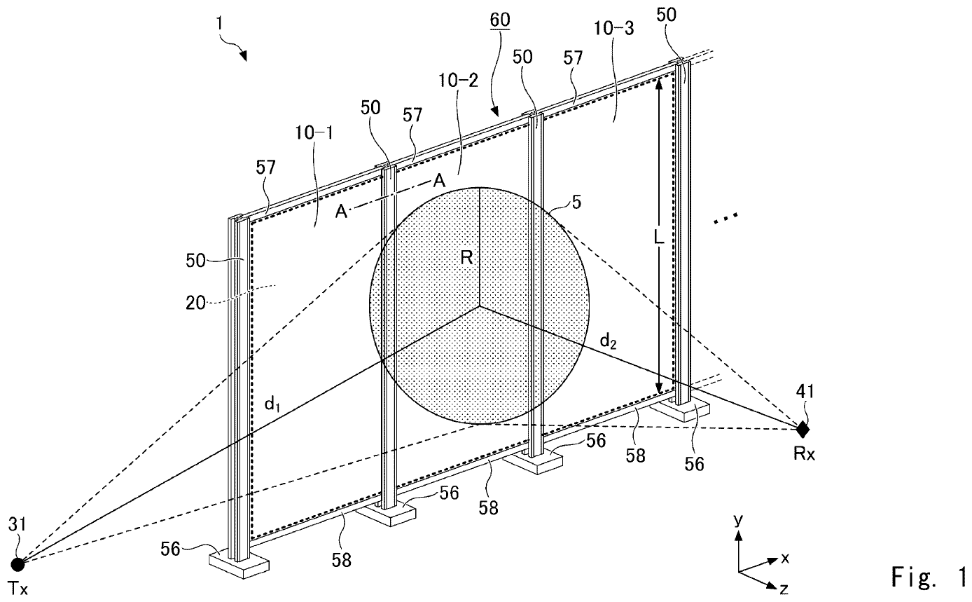

FIG. 1 is a schematic diagram of a radio transmission system 1 according to the embodiment. The radio transmission system 1 includes a transmitting antenna 31 which transmits an electromagnetic wave in a predetermined frequency band selected from frequencies of 1 GHz or higher and 300 GHz or lower, a receiving antenna 41 which receives an electromagnetic wave transmitted from the transmitting antenna 31, and an electromagnetic-wave reflecting apparatus 60 which forms a reflection surface 20 that reflects an electromagnetic wave in the above frequency band. When a distance from the transmitting antenna 31 to a reflection point on the reflection surface 20 is denoted as d1 [m], a distance from the reflection point to the receiving antenna 41 is denoted as d2 [m], and a wavelength of an electromagnetic wave in the above frequency band is denoted as λ [m],

$$\begin{matrix}[ Expression 1 ] & \\ L ≧ 2 \times \sqrt{\frac{λ {d}_{1} {d}_{2}}{{d}_{1} + {d}_{2}}} & ( 1 )\end{matrix}$$

the reflection surface 20 is formed so that a length L of a side or the short side thereof satisfies the above expression.

In the coordinate system shown in FIG. 1, the plane in which the electromagnetic-wave reflecting apparatus 60 is installed is defined as an XZ plane, and the height direction perpendicular to the XZ plane is defined as a Y direction. The X direction is a lateral or horizontal direction of the reflection surface 20 of the electromagnetic-wave reflecting apparatus 60, and the Y direction is a longitudinal or vertical direction of the reflection surface 20. The transmitting antenna 31 is, for example, an antenna of a transmitting station (Tx) such as a base station, and the receiving antenna 41 is an antenna of a receiving station (Rx) such as a mobile terminal. A radius R of a Fresnel zone 5 of the reflection surface 20 of an electromagnetic wave emitted from the transmitting antenna 31 is

$$R = \sqrt{\frac{λ {d}_{1} {d}_{2}}{{d}_{1} + {d}_{2}}} \qquad [ Expression 2 ]$$

expressed by the above expression. Therefore, if the length L of a side or the short side of the reflection surface 20 is greater than or equal to a diameter (2R) of the Fresnel zone 5, the electromagnetic-wave reflecting apparatus 60 functions.

The Fresnel zone indicates a range where the phase difference due to a difference between the optical path lengths of electromagnetic waves is smaller than π, and electromagnetic waves passing through the Fresnel zone 5 are intensified by each other and synthesized. Even if an obstacle is present within a Line of Sight (LOS) connecting the transmitting antenna 31 to the receiving antenna 41 in a straight line distance, radio communication is performed between the transmitting antenna 31 and the receiving antenna 41 as long as there is no obstacle that affects radio-wave propagation between the transmitting antenna 31 and the reflection surface 20 of the electromagnetic-wave reflecting apparatus 60 and between the reflection surface 20 and the receiving antenna 41.

The reflection surface 20 of the electromagnetic-wave reflecting apparatus 60 does not need to be formed of one reflection panel, and may instead be formed of a plurality of reflection panels. For example, by connecting reflection panels 10-1, 10-2, and 10-3 (hereinafter they may be collectively referred to as “reflection panels 10”) by frames 50, an electromagnetic-wave reflecting apparatus 60 having an extended reflection area can be obtained. As long as the expression (1) is satisfied, the electromagnetic-wave reflecting apparatus 60 may be formed by connecting a plurality of the reflection panels 10 to each other, or formed of one reflection panel 10. The number of the reflection panels 10 to be connected to each other is not limited to three, and may instead be two or four or more. A direction in which the reflection panels 10 are connected to each other is not limited to the lateral direction or the X direction, and a plurality of the reflection panels 10 may be connected to each other in the longitudinal direction or the Y direction on a wall surface or the like. When the reflection panels are connected to each other in the Y direction, frames having the same configuration as that of the frame 50 may be used as a top frame 57 and a bottom frame 58. By allowing the reflection panels 10 to be connected to each other by the frames 50, the size of the reflection surface 20 can be adjusted according to an environment in which the radio transmission system 1 is introduced and a position of the transmitting antenna 31.

The transmitting antenna 31 has directivity and gains determined according to the size, the shape, the application, and the like of a space in which the base station is introduced. As an example, the maximum gain of the transmitting antenna 31 according to the embodiment is 5 dBi or higher and 30 dBi or lower. Electromagnetic waves emitted from the transmitting antenna 31 are reflected by the reflection surface 20 of the electromagnetic-wave reflecting apparatus 60 and received by the receiving antenna 41. Even when the transmitting antenna 31 and the receiving antenna 41 are not located within the LOS, radio communication can be performed between the transmitting antenna 31 and the receiving antenna 41 by installing the electromagnetic-wave reflecting apparatus 60 so as to satisfy the expression (1).

The electromagnetic-wave reflecting apparatus 60 includes at least one reflection panel 10 and the frames 50 that hold the reflection panel 10. As shown in FIG. 1, when the reflection surface 20 of a required size is formed of a plurality of the reflection panels 10-1, 10-2, and 10-3, the reflection panels 10-1, 10-2, and 10-3 can be connected to each other by the frames 50. Each of the reflection panels 10 can reflect an electromagnetic wave in a frequency band used in the radio transmission system 1.

The reflection surface 20 formed of one or more reflection panels 10 includes at least one of a specular reflection surface and a non-specular reflection surface. The specular reflection surface reflects an incident electromagnetic wave at an angle equal to an incident angle. The non-specular reflection surface reflects an incident electromagnetic wave in a manner different from that by which specular reflection is performed. The non-specular reflection surface may include a metasurface which is an artificial reflection surface whose reflection characteristics are controlled. The metasurface is formed of periodic structures or patterns that are finer than a wavelength, and reflects or diffuses an incident electromagnetic wave at an angle different from an incident angle. The metasurface may be designed to reflect radio waves in a specific direction, or may be designed to reflect them in a different diffusion manner.

The electromagnetic-wave reflecting apparatus 60 may include leg parts 56 so that they are installed in an upright position on an installation surface. The leg parts 56 may be detachably connected to the frames 50. The leg parts 56 may be provided with casters with locks so that the electromagnetic-wave reflecting apparatus 60 can be moved and installed at a desired place, or the leg parts 56 may be configured to be fixed to an installation surface with screws or the like. An electromagnetic-wave reflecting apparatus 60 may be attached to a wall or a ceiling without using the leg parts 56. The reflection panels 10 may be connected to each other in the Y direction, that is, the longitudinal direction, by holding the upper and the lower ends of the reflection panels 10 with the respective top frames 57 and bottom frames 58, each of which has the same configuration as that of the frame 50, as shown in FIG. 1.

When the reflection surface 20 is formed by connecting a plurality of the reflection panels 10 to each other, each of the frames 50, the top frames 57, and the bottom frames 58 may be formed of a conductive material or a dielectric material that does not affect the reflection characteristics of the electromagnetic-wave reflecting apparatus 60 as much as possible. For example, each of them may be formed of a conductive material having electrical characteristics close to the reflection characteristics of the reflection panels 10. When each of the reflection panels 10 has a specular reflection surface, at least parts of the frames 50 are preferably formed of a conductive material in order to make the reflection potential continuous between the reflection panels 10 adjacent to each other. However, the continuity of the reflection potential is not indispensable in the case of a metasurface. In this case, the frames 50 may be formed of dielectric materials which transmit electromagnetic waves of the used frequency.

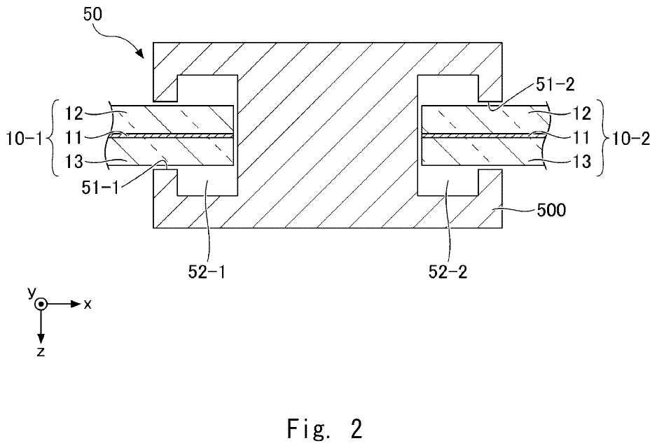

FIG. 2 is an example of a structure of a horizontal cross section of the frame 50 along a line A-A shown in FIG. 1. This horizontal cross section is a cross section in a plane parallel to the XZ plane. The frame 50 includes, for example, a main part 500 formed of a conductor such as aluminum, slits 55-1 and 55-2 formed in the main part 500, and spaces 52-1 and 52-2 which respectively communicate with the slits 55-1 and 55-2. The reflection panels 10-1 and 10-2 are respectively inserted and held in the slits 55-1 and 55-2 opposed to each other in the X direction of the frame 50.

The reflection panel 10 includes, for example, a conductive layer 11 serving as a reflection functional layer between two dielectric plates 12 and 13. Each of the dielectric plates 12 and 13 is, for example, a dielectric resin plate having a thickness of 1 mm or more and 8 mm or less. The conductive layer 11 serves as a surface that forms the reflection surface 20 of the reflection panel 10 and may be formed of a metal mesh, a periodic pattern, a geometric pattern, a transparent conductive film, or the like. As an example, the conductive layer 11 includes a metal mesh formed of a good conductor such as Cu, Ni, SUS, Ag, or the like. When the reflection panel 10 includes a metasurface in a part thereof, the conductive layer 11 may include a pattern that includes a periodic array of a plurality of metal elements. The conductive layer 11 has a thickness of 10 μm or more and 200 μm or less, and preferably 50 μm or more and 150 μm or less, so as to sufficiently function as a reflection surface that reflects an electromagnetic wave having a desired frequency in a designed direction.

The reflection panels 10-1 and 10-2 are respectively inserted into the slits 55-1 and 55-2 on the respective sides of the frame 50 in the X direction, and are respectively held inside the spaces 52-1 and 52-2. The spaces 52-1 and 52-2 are not indispensable. However, it is possible to reduce the weight of the main part 500 of the frame 50 and provide some margin to the holding angles of the reflection panels 10-1 and 10-2 by providing the spaces 52-1 and 52-2.

The reflection panels 10-1 and 10-1 adjacent to each other can be stably held by inserting the reflection panels 10-2 and 10-2 into the slits 51-1 and 51-2, respectively. A part of the main part 500 may be formed of a non-conductive material. A non-conductive cover made of resin or the like may be provided on the outer surface of the main part 500.

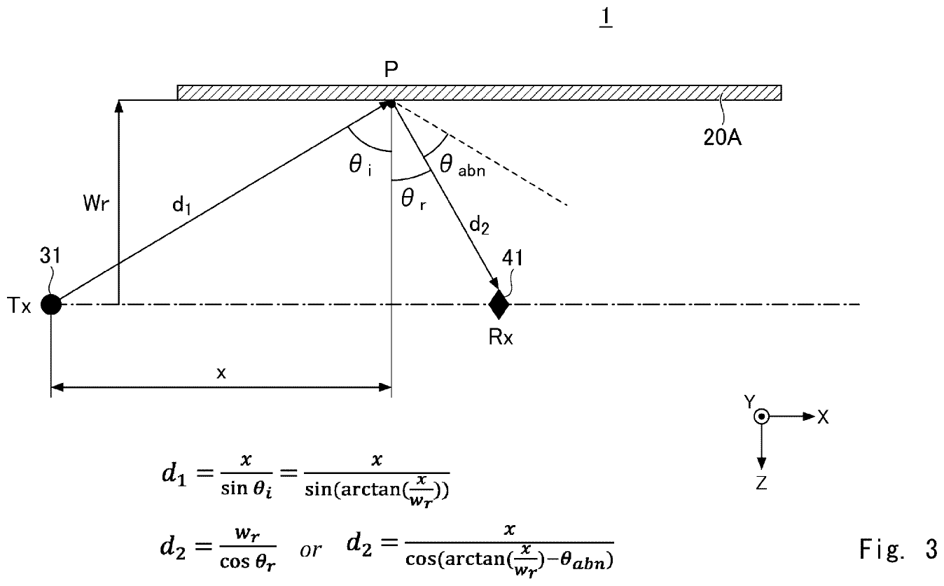

FIG. 3 is a schematic diagram showing reflection on a reflection surface 20A including a metasurface. A distance from the transmitting antenna 31 to a reflection point P on the reflection surface 20A is denoted as d1, and a distance from the reflection point P to the receiving antenna 41 is denoted as d2. The reflection surface 20A including the metasurface forms a non-specular reflection surface. When an incident angle is denoted as θi and a reflection angle is denoted as θr, θi≠θr holds. A difference between a reflection angle by specular reflection and the reflection angle θr by non-specular reflection is denoted as θabn.

In FIG. 3, in order to simplify the explanation, the transmitting antenna 31 and the receiving antenna 41 are positioned on the same line parallel to the reflection surface 20A in the XZ plane. However, the present disclosure is not limited to this example. The distance d1 from the transmitting antenna 31 to the reflection point P is expressed by the expression (2).

$$\begin{matrix}tan {θ}_{i} = \frac{x}{{w}_{r}} & {θ}_{i} = arctan ( \frac{x}{{w}_{r}} )\end{matrix} \qquad [ Expression 3 ]$$

$${d}_{1} = \frac{x}{sin {θ}_{i}} = \frac{x}{sin ( arctan ( \frac{x}{{w}_{r}} ) )} \qquad ( 2 )$$

In this expression, x is the distance between the transmitting antenna 31 and the normal at the reflection point P, and Wr is the length of the perpendicular line from the transmitting antenna 31 to the reflection surface 20A.

Meanwhile, the distance d2 from the reflection point P to the receiving antenna 41 is expressed by the expression (3) using the reflection angle θr.

$$\begin{matrix}{d}_{2} = \frac{{w}_{r}}{cos {θ}_{r}} & {θ}_{r} = {θ}_{i} - {θ}_{abn}\end{matrix} = arctan ( \frac{x}{{w}_{r}} ) - {θ}_{abn} \qquad [ Expression 4 ]$$

$${d}_{2} = \frac{x}{cos ( arctan ( \frac{x}{{w}_{r}} ) - {θ}_{abn} )} \qquad ( 3 )$$

A position where the electromagnetic-wave reflecting apparatus 60 is installed and the size L of a side or the short side are determined so as to satisfy the expression (1) by using the distances d1 and d2 obtained by the expressions (2) and (3) and the wavelength λ of the electromagnetic wave to be used. When a length Wr′ of the perpendicular line from the receiving antenna 41 to the reflection surface 20A is different from a length Wr of the perpendicular line from the transmitting antenna 31 to the reflection surface 20A, d2 may be obtained by Wr′/cos θr. The length Wr′ of the perpendicular line from the receiving antenna 41 to the reflection surface 20A can be easily measured, and the reflection angle θr is determined in advance by the design of the metasurface. Further, the distance d2 between the reflection point P and the receiving antenna 41 may be directly set within a predetermined range so that the reflection point P is located in or near the center of the reflection surface 20A.

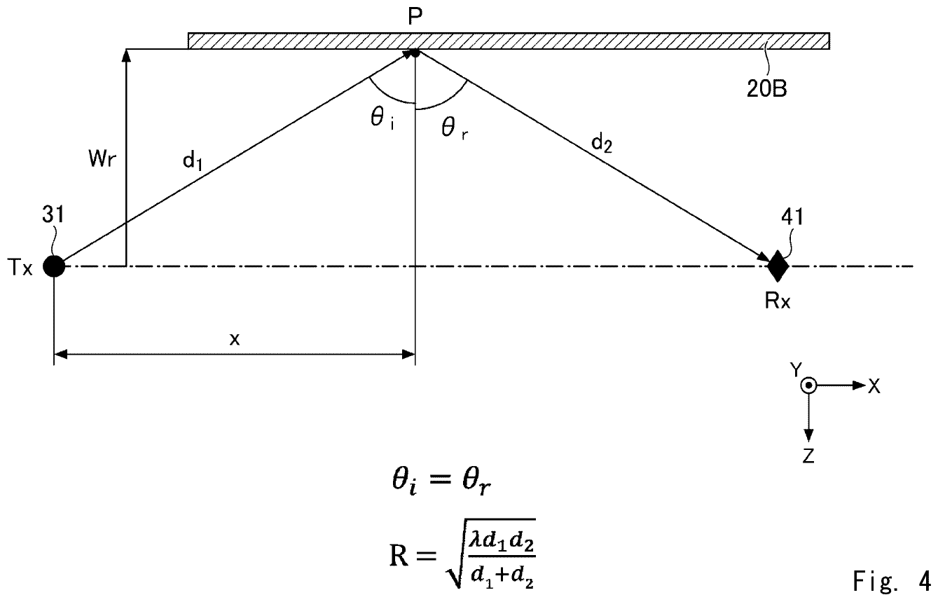

FIG. 4 is a schematic diagram showing reflection on a reflection surface 20B, which is a specular reflection surface. In the case of specular reflection, the incident angle θi and the reflection angle θr are the same (θi=θr). In FIG. 4, in order to make it easy to understand the illustration, the transmitting antenna 31 and the receiving antenna 41 are arranged on a line parallel to the reflection surface 20B in the XZ plane. However, the present disclosure is not limited to this example.

In both the case of non-specular reflection in FIG. 3 and the case of specular reflection in FIG. 4, the position and the direction of the electromagnetic-wave reflecting apparatus 60 may be determined so that the distance d1 from the transmitting antenna 31 to the reflection point P is longer than the distance d2 from the reflection point P to the receiving antenna 41 (d1> d2) in view of antenna gains and attenuation. In this case as well, the electromagnetic-wave reflecting apparatus 60 is assembled so that a side or a short side L of the reflection surface 20 is 2R or greater. When the radio transmission system 1 using the electromagnetic-wave reflecting apparatus 60 is introduced into a facility, a reasonable range of the communication distance d1+d2 between the transmitting antenna 31 and the receiving antenna 41 through the electromagnetic-wave reflecting apparatus 60 is, for example, longer than 0.3 m and shorter than or equal to 500.0 m (0.3<d1+d2≤500.0 m), and preferably 0.5 m or longer and 500 m or shorter. When d1+d2 is 0.3 m or shorter, the probability that an obstacle is present between the transmitting antenna 31 and the receiving antenna 41 is low, and the necessity and the significance of radio communication through the electromagnetic-wave reflecting apparatus 60 are small. When d1+d2 exceeds 500.0 m, the reflected wave is less likely to reach the receiving antenna 41 even if the electromagnetic-wave reflecting apparatus 60 is used, although it depends on the antenna gain. In order to improve the reception quality, the size L (i.e., 2R) of a side or the short side of the reflection surface 20A or 20B of the electromagnetic-wave reflecting apparatus 60 is longer than 0.3 m, and preferably 0.5 m or longer.

### <Design Example of Radio Transmission System>

A design example of the radio transmission system 1 using the electromagnetic-wave reflecting apparatus 60 will be described below. In the following design example, it is assumed that the receiving station Rx is located in a blind zone where it is difficult to directly receive radio waves from the transmitting station Tx. The electromagnetic-wave reflecting apparatus is installed so that the reflection point of a radio wave emitted from the transmitting station Tx is located substantially in the center of the reflection surface.

### Example 1

Example 1 is Example 1 according to the present disclosure. In the radio transmission system 1, a frequency band of 28.0 GHz was used. The maximum gain of the transmitting antenna 31 was 20 dBi, and the wavelength λ of the electromagnetic wave transmitted from the transmitting antenna 31 was 10.7 mm. A reflection surface 20B was formed by an electromagnetic-wave reflecting apparatus 60 using one reflection panel 10 having specular reflection characteristics and a width of 1.0 m and a length of 2.0 m. The size of the reflection surface 20B was 1.0 m×2.0 m. The electromagnetic-wave reflecting apparatus 60 was installed so that the diameter 2R of the Fresnel zone 5 was smaller than or equal to the size of the short side of the reflection surface 20B, i.e., 1.0 m, based on the position of the transmitting station Tx. The distance d1 from the transmitting antenna 31 to the reflection point on the reflection surface 20B was 50.0 m, and the distance d2 from the reflection point to the receiving antenna 41 was 25.0 m. The diameter 2R of the Fresnel zone 5 was 0.84 m, which was smaller than the short side of the reflection surface 20B of the electromagnetic-wave reflecting apparatus 60, i.e., 1.0 m. The change in the received power in the receiving antenna 41 between before and after the installation of the electromagnetic-wave reflecting apparatus 60 was +25 dB, and it was confirmed that the reception quality was improved.

### Example 2

Example 2 is Example 2 according to the present disclosure. In the radio transmission system 1, a frequency band of 28.0 GHz was used. The maximum gain of the transmitting antenna 31 was 20 dBi, and the wavelength λ of the electromagnetic wave transmitted from the transmitting antenna 31 was 10.7 mm. A reflection surface 20B of 5.0 m×2.0 m was formed by connecting five reflection panels 10, each of which has specular reflection characteristics and a width of 1.0 m and a length of 2.0 m, to each other in the lateral direction (the x direction). The electromagnetic-wave reflecting apparatus 60 was installed so that the diameter 2R of the Fresnel zone 5 was smaller than or equal to the size of the short side of the reflection surface 20B, i.e., 2.0 m, based on the position of the transmitting station Tx. The distance d1 from the transmitting antenna 31 to the reflection point on the reflection surface 20B was 75.0 m, and the distance d2 from the reflection point to the receiving antenna 41 was 25.0 m. The diameter 2R of the Fresnel zone 5 was 0.90 m, which was smaller than the short side of the reflection surface 20B of the electromagnetic-wave reflecting apparatus 60, i.e., 2.0 m. The change in the received power in the receiving antenna 41 between before and after the installation of the electromagnetic-wave reflecting apparatus 60 was +20 dB, and it was confirmed that the reception quality was improved.

### Example 3

Example 3 is Example 3 according to the present disclosure. In the radio transmission system 1, a frequency band of 28.0 GHz was used. The maximum gain of the transmitting antenna 31 was 20 dBi, and the wavelength λ of the electromagnetic wave transmitted from the transmitting antenna 31 was 10.7 mm. A reflection surface 20B of 50.0 m×2.0 m was formed by connecting 50 reflection panels 10, each of which has specular reflection characteristics and a width of 1.0 m and a length of 2.0 m, to each other in the lateral direction (the x direction). The electromagnetic-wave reflecting apparatus 60 was installed so that the diameter 2R of the Fresnel zone 5 was smaller than or equal to the size of the short side of the reflection surface 20B, i.e., 2.0 m, based on the position of the transmitting station Tx. The distance d1 from the transmitting antenna 31 to the reflection point on the reflection surface 20B was 400.0 m, and the distance d2 from the reflection point to the receiving antenna 41 was 100.0 m. The diameter 2R of the Fresnel zone 5 was 1.85 m, which was smaller than the short side of the reflection surface 20B of the electromagnetic-wave reflecting apparatus 60, i.e., 2.0 m. The change in the received power in the receiving antenna 41 between before and after the installation of the electromagnetic-wave reflecting apparatus 60 was +10 dB, and it was confirmed that the reception quality was improved.

### Example 4

Example 4 is Example 4 according to the present disclosure. In the radio transmission system 1, a frequency band of 4.8 GHz was used. The maximum gain of the transmitting antenna 31 was 20 dBi, and the wavelength λ of the electromagnetic wave transmitted from the transmitting antenna 31 was 62.5 mm. A reflection surface 20B of 10.0 m×2.0 m was formed by connecting 10 reflection panels 10, each of which has specular reflection characteristics and a width of 1.0 m and a length of 2.0 m, to each other in the lateral direction (the x direction). The electromagnetic-wave reflecting apparatus 60 was installed so that the diameter 2R of the Fresnel zone 5 was smaller than or equal to the size of the long side of the reflection surface 20B, i.e., 10.0 m, based on the position of the transmitting station Tx. The distance d1 from the transmitting antenna 31 to the reflection point on the reflection surface 20B was 300.0 m, and the distance d2 from the reflection point to the receiving antenna 41 was 200.0 m. The diameter 2R of the Fresnel zone 5 was 5.48 m, which exceeded the short side of the reflection surface 20B of the electromagnetic-wave reflecting apparatus 60, i.e., 2.0 m. However, it was smaller than the long side, i.e., 10.0 m. The change in the received power in the receiving antenna 41 between before and after the installation of the electromagnetic-wave reflecting apparatus 60 was +15 dB, and it was confirmed that the reception quality was improved. If the diameter 2R of the Fresnel zone is smaller than the long side of the reflection surface 20B, and the short side L of the reflection surface 20B covers ⅓ or more of the area thereof in the radial direction from the center of the Fresnel zone, the reception quality is improved.

### Example 5

Example 5 is Example 5 according to the present disclosure. In the radio transmission system 1, a frequency band of 4.8 GHz was used. The maximum gain of the transmitting antenna 31 was 20 dBi, and the wavelength λ of the electromagnetic wave transmitted from the transmitting antenna 31 was 62.5 mm. A reflection surface 20B of 5.0 m×2.0 m was formed by connecting five reflection panels 10, each of which has specular reflection characteristics and a width of 1.0 m and a length of 2.0 m, to each other in the lateral direction (the x direction). The electromagnetic-wave reflecting apparatus 60 was installed so that the diameter 2R of the Fresnel zone 5 was smaller than or equal to the size of the long side of the reflection surface 20B, i.e., 5.0 m, based on the position of the transmitting station Tx. The distance d1 from the transmitting antenna 31 to the reflection point on the reflection surface 20B was 450.0 m, and the distance d2 from the reflection point to the receiving antenna 41 was 50.0 m. The diameter 2R of the Fresnel zone 5 was 3.35 m, which exceeded the short side of the reflection surface 20B of the electromagnetic-wave reflecting apparatus 60, i.e., 2.0 m. However, it was smaller than the long side, i.e., 5.0 m. The change in the received power in the receiving antenna 41 between before and after the installation of the electromagnetic-wave reflecting apparatus 60 was +7 dB, and it was confirmed that the reception quality was improved. Since the diameter 2R of the Fresnel zone was smaller than the long side of the reflection surface 20B, and the short side L of the reflection surface 20B covered about 60% of the area thereof in the radial direction from the center of the Fresnel zone, the reception quality was improved.

### Example 6

Example 6 is Example 6 according to the present disclosure. In the radio transmission system 1, a frequency band of 4.8 GHz was used. The maximum gain of the transmitting antenna 31 was 20 dBi, and the wavelength λ of the electromagnetic wave transmitted from the transmitting antenna 31 was 62.5 mm. A reflection surface 20B of 100.0 m×2.0 m was formed by connecting 100 reflection panels 10, each of which has specular reflection characteristics and a width of 1.0 m and a length of 2.0 m, to each other in the lateral direction (the x direction). The electromagnetic-wave reflecting apparatus 60 was installed so that the diameter 2R of the Fresnel zone 5 was smaller than or equal to the size of the long side of the reflection surface 20B based on the position of the transmitting station Tx. The distance d1 from the transmitting antenna 31 to the reflection point on the reflection surface 20B was 450.0 m, and the distance d2 from the reflection point to the receiving antenna 41 was 50.0 m. The diameter 2R of the Fresnel zone 5 was 3.35 m, which exceeded the short side of the reflection surface 20B of the electromagnetic-wave reflecting apparatus 60, i.e., 2.0 m. However, it was smaller than the long side, i.e., 100.0 m. The change in the received power in the receiving antenna 41 between before and after the installation of the electromagnetic-wave reflecting apparatus 60 was +9 dB, and it was confirmed that the reception quality was improved. Since the diameter 2R of the Fresnel zone was smaller than the long side of the reflection surface 20B, and the short side L of the reflection surface 20B covered about 60% of the area thereof in the radial direction from the center of the Fresnel zone, the reception quality was improved.

### Example 7

Example 7 is Example 7 according to the present disclosure. In the radio transmission system 1, a frequency band of 28.0 GHz was used. The maximum gain of the transmitting antenna 31 was 20 dBi, and the wavelength λ of the electromagnetic wave transmitted from the transmitting antenna 31 was 10.7 mm. A reflection surface 20A is formed by the electromagnetic-wave reflecting apparatus 60 using one reflection panel 10 of a metasurface having a width of 0.7 m and a length of 0.7 m. The size of the reflection surface 20A is 0.7 m×0.7 m, and the electromagnetic-wave reflecting apparatus 60 was installed so that the diameter 2R of the Fresnel zone 5 was smaller than or equal to the size of a side of the reflection surface 20A, i.e., 0.7 m, based on the position of the transmitting station Tx. The distance d1 from the transmitting antenna 31 to the reflection point on the reflection surface 20A was 30.0 m, and the distance d2 from the reflection point to the receiving antenna 41 located in a direction different from the direction of regular reflection was 10.0 m. The diameter 2R of the Fresnel zone 5 was 0.56 m, which was smaller than a side of the reflection surface 20A of the electromagnetic-wave reflecting apparatus 60, i.e., 0.7 m. The change in the received power in the receiving antenna 41 between before and after the installation of the electromagnetic-wave reflecting apparatus 60 was +12 dB, and it was confirmed that the reception quality was improved.

### Example 8

Example 8 is Example 8 according to the present disclosure. In the radio transmission system 1, a frequency band of 28.0 GHz was used. The maximum gain of the transmitting antenna 31 was 20 dBi, and the wavelength λ of the electromagnetic wave transmitted from the transmitting antenna 31 was 10.7 mm. A reflection surface 20A of a metasurface of 2.1 m×2.1 m was formed by connecting three reflection panels 10 of a metasurface, each of which has a width of 0.7 m and a length of 0.7 m, to each other in each of the X direction (the lateral direction) and the Y direction (the longitudinal direction), i.e., by using nine reflection panels 10. The electromagnetic-wave reflecting apparatus 60 was installed so that the diameter 2R of the Fresnel zone 5 was smaller than or equal to the size of a side of the reflection surface 20A, i.e., 2.1 m, based on the position of the transmitting station Tx. The distance d1 from the transmitting antenna 31 to the reflection point on the reflection surface 20A was 50.0 m, and the distance d2 from the reflection point to the receiving antenna 41 located in a direction different from the direction of regular reflection was 30.0 m. The diameter 2R of the Fresnel zone 5 was 0.90 m, which was smaller than a side of the reflection surface 20A of the electromagnetic-wave reflecting apparatus 60, i.e., 2.1 m. The change in the received power in the receiving antenna 41 between before and after the installation of the electromagnetic-wave reflecting apparatus 60 was +10 dB, and it was confirmed that the reception quality was improved.

### Example 9

Example 9 is Comparative Example 1. In the radio transmission system 1, a frequency band of 4.8 GHz was used. The maximum gain of the transmitting antenna 31 was 20 dBi, and the wavelength λ of the electromagnetic wave transmitted from the transmitting antenna 31 was 62.5 mm. A reflection surface 20B of 10.0 m×2.0 m was formed by connecting 10 specular reflection panels 10, each of which has a width of 1.0 m and a length of 2.0 m, to each other in the X direction (the lateral direction). The electromagnetic-wave reflecting apparatus 60 was installed so that the distance d1 from the transmitting antenna 31 to the reflection point on the reflection surface 20B was 500.0 m and the distance d2 from the reflection point to the receiving antenna 41 was 50.0 m. The diameter 2R of the Fresnel zone 5 was 3.37 m, which was smaller than the length of the long side of the reflection surface 20B, i.e., 10.0 m. However, it exceeded the length of the short side, i.e., 2.0 m. There was no significant change in the received power in the receiving antenna 41 between before and after the installation of the electromagnetic-wave reflecting apparatus 60, and no improvement was observed in the reception quality. The communication distance (d1+d2) through the electromagnetic-wave reflecting apparatus 60 was 550 m, which was long, and the distance from the transmitting antenna 31 to the reflection surface 20B was particularly long, and therefore it was difficult to improve the reception quality even when the electromagnetic-wave reflecting apparatus 60 was used.

### Example 10

Example 10 is Comparative Example 2. In the radio transmission system 1, a frequency band of 28.0 GHz was used. The maximum gain of the transmitting antenna 31 was 20 dBi, and the wavelength λ of the electromagnetic wave transmitted from the transmitting antenna 31 was 10.7 mm. A reflection surface 20B of 0.15 m×0.15 m was formed by using one specular reflection panel 10 having a width of 0.15 m and a length of 0.15 m. The electromagnetic-wave reflecting apparatus 60 was installed so that the distance d1 from the transmitting antenna 31 to the reflection point on the reflection surface 20B was 50.0 m and the distance d2 from the reflection point to the receiving antenna 41 was 25.0 m. There was no significant change in the received power in the receiving antenna 41 between before and after the installation of the electromagnetic-wave reflecting apparatus 60, and no improvement was observed in the reception quality. The diameter 2R of the Fresnel zone 5 at this time was 0.84 m, which was more than three times the size of a side of the reflection surface 20B of the electromagnetic-wave reflecting apparatus 60, i.e., 0.15 m, and the loss was large.

### Example 11

Example 11 is Comparative Example 3. In the radio transmission system 1, a frequency band of 28.0 GHz was used. The maximum gain of the transmitting antenna 31 was 20 dBi, and the wavelength λ of the electromagnetic wave transmitted from the transmitting antenna 31 was 10.7 mm. A reflection surface 20B of 0.3 m×0.3 m was formed by using one specular reflection panel 10 having a width of 0.3 m and a length of 0.3 m. The electromagnetic-wave reflecting apparatus 60 was installed so that the distance d1 from the transmitting antenna 31 to the reflection point on the reflection surface 20B was 0.2 m and the distance d2 from the reflection point to the receiving antenna 41 was 0.1 m. There was no significant change in the received power in the receiving antenna 41 between before and after the installation of the electromagnetic-wave reflecting apparatus 60, and no improvement was observed in the reception quality. The diameter 2R of the Fresnel zone 5 was 0.05 m, which was smaller than the size of a side of the reflection surface 20B of the electromagnetic-wave reflecting apparatus 60, i.e., 0.3 m. However, the distances d1 and d2 were too short. It is considered that, since the positions of the transmitting antenna 31 and the receiving antenna 41 were too close to the reflection surface 20B, there was no sufficient space for an obstacle to enter between them, and hence there was no change in the reception quality. Conversely, if the communication distance (d1+d2) is too small, the necessity to provide the electromagnetic-wave reflecting apparatus 60 is small. Further, since the diameter 2R of the Fresnel zone on the reflection surface 20B was too small, it was difficult to effectively improve the reception quality.

The following matters are derived from the results of Examples 1 to 11.
(1) As a practical arrangement of the radio transmission system 1 introduced into a facility, the distance d1 from the transmitting antenna 31 to the reflection point on the reflection surface 20 is preferably longer than or equal to the distance d2 from the reflection point to the receiving antenna 41, and the communication distance (d1+d2) through the electromagnetic-wave reflecting apparatus 60 is preferably longer than 0.3 m and shorter than or equal to 500.0 m (0.3 m<d1+d2≤500.0 m).
(2) In the above radio transmission system 1, the diameter 2R of the Fresnel zone is preferably the length of a side or the short side of the reflection surface 20.
(3) In a case where the diameter 2R of the Fresnel zone is smaller than the length of the long side of the reflection surface but exceeds the length of the short side thereof, the reception quality is improved when the short side of the reflection surface covers ⅓ or more of the area thereof in the radial direction from the center of the Fresnel zone. Conversely, the reception quality may be improved when the length of the long side of the reflection surface 20 is greater than or equal to the diameter of the Fresnel zone and the length of the short side of the reflection surface 20 is longer than or equal to ⅓ of the diameter of the Fresnel zone.
(4) As the size of the reflection surface 20 contributing to the improvement of the reception quality, a side or the short side thereof is preferably longer than 0.3 m.
(5) The above configurations (1) to (4) also apply to both the case where the reflection surface 20 is a metasurface and the case where it is a specular reflection surface.

The radio transmission system 1 according to the embodiment is applied to a predetermined facility and a building, such as a commercial facility, an office, and a tunnel, in addition to a production line in a factory. The size of the reflection surface 20A or 20B of the electromagnetic-wave reflecting apparatus 60 can be adjusted using one or more reflection panels 10 as appropriate.

Embodiments according to the present disclosure have been described above, but the present disclosure may also include configurations described hereinafter.

### (Item 1)

A radio transmission system comprising:
a transmitting antenna configured to transmit a radio wave in a predetermined frequency band selected from frequencies of 1 GHz or higher and 300 GHz or lower;
a receiving antenna configured to receive a radio wave in the frequency band; and
an electromagnetic-wave reflecting apparatus configured to form a reflection surface which reflects a radio wave in the frequency band, wherein
the electromagnetic-wave reflecting apparatus includes a reflection surface formed of one or more reflection panels, and
when a distance from the transmitting antenna to a reflection point on the reflection surface is denoted as d1 [m], a distance from the reflection point to the receiving antenna is denoted as d2 [m], and a wavelength of the frequency band is denoted as λ [m], a length L [m] of a side or a short side of the reflection surface is formed so as to satisfy

L≥2×[λ·d1·d2/(d1+d2)]^{1/2}.

### (Item 2)

A radio transmission system comprising:
a transmitting antenna configured to transmit a radio wave in a predetermined frequency band selected from frequencies of 1 GHz or higher and 300 GHz or lower;
a receiving antenna configured to receive a radio wave in the frequency band; and
an electromagnetic-wave reflecting apparatus configured to form a reflection surface which reflects a radio wave in the frequency band, wherein
the electromagnetic-wave reflecting apparatus includes a reflection surface formed of one or more reflection panels, and
when a distance from the transmitting antenna to a reflection point on the reflection surface is denoted as d1 [m], a distance from the reflection point to the receiving antenna is denoted as d2 [m], and a wavelength of the frequency band is denoted as λ [m], a length of a long side of the reflection surface is greater than or equal to a diameter of a Fresnel zone represented by 2×[λ·d1·d2/(d1+d2)]^{1/2}, and a length of a short side of the reflection surface is greater than or equal to ⅓ of the diameter of the Fresnel zone.

### (Item 3)

The radio transmission system according to Item 1 or 2, wherein the electromagnetic-wave reflecting apparatus comprises a frame configured to connect two or more reflection panels to each other in a first direction or a second direction that is different from the first direction, and a size of the reflection surface is adjustable.

### (Item 4)

The radio transmission system according to Item 3, wherein the frame includes a slit configured to connect the two or more reflection panels in a lateral direction or a longitudinal direction of the reflection panel.

### (Item 5)

The radio transmission system according to any one of Items 1 to 4, wherein the distance d1 from the transmitting antenna to the reflection point is longer than or equal to the distance d2 from the reflection point to the receiving antenna, and a sum total of d1 and d2 is longer than 0.3 m and shorter than or equal to 500.0 m.

### (Item 6)

The radio transmission system according to any one of Items 1 to 5, wherein the reflection surface is a metasurface or a specular reflection surface.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A radio transmission system comprising:
a transmitting antenna configured to transmit a radio wave in a predetermined frequency band selected from frequencies of 1 GHz or higher and 300 GHz or lower;
a receiving antenna configured to receive a radio wave in the frequency band; and
an electromagnetic-wave reflecting apparatus configured to form a reflection surface which reflects a radio wave in the frequency band, wherein
the electromagnetic-wave reflecting apparatus includes a reflection surface formed of one or more reflection panels, and
when a distance from the transmitting antenna to a reflection point on the reflection surface is denoted as d1 [m], a distance from the reflection point to the receiving antenna is denoted as d2 [m], and a wavelength of the frequency band is denoted as λ [m], a length L [m] of a side or a short side of the reflection surface is formed so as to satisfy
$$L \geq 2 \times {[ λ \cdot d 1 \cdot d 2 / ( d 1 + d 2 ) ]}^{1 / 2} .$$

2. A radio transmission system comprising:
a transmitting antenna configured to transmit a radio wave in a predetermined frequency band selected from frequencies of 1 GHz or higher and 300 GHz or lower;
a receiving antenna configured to receive a radio wave in the frequency band; and
an electromagnetic-wave reflecting apparatus configured to form a reflection surface which reflects a radio wave in the frequency band, wherein
the electromagnetic-wave reflecting apparatus includes a reflection surface formed of one or more reflection panels, and
when a distance from the transmitting antenna to a reflection point on the reflection surface is denoted as d1 [m], a distance from the reflection point to the receiving antenna is denoted as d2 [m], and a wavelength of the frequency band is denoted as λ [m], a length of a long side of the reflection surface is greater than or equal to a diameter of a Fresnel zone represented by 2×[λ·d1·d2/(d1+d2)]^{1/2}, and a length of a short side of the reflection surface is greater than or equal to ⅓ of the diameter of the Fresnel zone.

3. The radio transmission system according to claim 1, wherein the electromagnetic-wave reflecting apparatus comprises a frame configured to connect two or more reflection panels to each other in a first direction or a second direction that is different from the first direction, and a size of the reflection surface is adjustable.

4. The radio transmission system according to claim 3, wherein the frame includes a slit configured to connect the two or more reflection panels in a lateral direction or a longitudinal direction of the reflection panel.

5. The radio transmission system according to claim 1, wherein the distance d1 from the transmitting antenna to the reflection point is longer than or equal to the distance d2 from the reflection point to the receiving antenna, and a sum total of d1 and d2 is longer than 0.3 m and shorter than or equal to 500.0 m.

6. The radio transmission system according to claim 1, wherein the reflection surface is a metasurface or a specular reflection surface.
